(19) United States
(12) Patent Application Publication
(10) Pub. No.: US 2014/0282090 A1
(43) Pub. Date: Sep. 18, 2014

(54) Displaying Image Information from a Plurality of Devices

(71) Applicants: Xeth Waxman, Scottsdale, AZ (US); Paul Clayton Fowler, Scottsdale, AZ (US); Mike McClaran, Phoenix, AZ (US)

(72) Inventors: Xeth Waxman, Scottsdale, AZ (US); Paul Clayton Fowler, Scottsdale, AZ (US); Mike McClaran, Phoenix, AZ (US)

(21) Appl. No.: 13/829,045

(22) Filed: Mar. 14, 2013

(51) Int. Cl. H04L 29/06

(52) U.S. Cl. CPC H04L 65/403
USPC 715/753

(57) ABSTRACT

Displaying image information from a plurality of devices includes receiving first image information corresponding to part of a first image displayed on a first device of a plurality of devices. The first image information is determined according to first anchor information. Second image information corresponding to part of a second image displayed on a second device of the plurality of devices is received. The second image information is determined according to second anchor information. Using a processor, a representation of the first image is created based on the first image information and the first anchor information. Using the processor, a representation of the second image is created based on the second image information and the second anchor information. The representation of the first image and the representation of the second image are presented simultaneously on the third device.

### TECHNICAL FIELD

This invention relates generally to displaying image information and, more particularly, to displaying image information from a plurality of devices.

### BACKGROUND

Incorporation of technology into the classroom has been an increasing trend in recent years. Communication systems allow teachers to provide more information to, and receive more feedback from, their students. However, the technological elements have limits on the data that can be shared. These limits reduce the overall efficiency of the education process.

### SUMMARY OF EXAMPLE EMBODIMENTS

In accordance with particular embodiments, disadvantages and problems associated with previous techniques for displaying image information may be reduced or eliminated.

According to an embodiment, displaying image information from a plurality of devices includes receiving first image information corresponding to part of a first image displayed on a first device of a plurality of devices. The first image information is determined according to first anchor information. Second image information corresponding to part of a second image displayed on a second device of the plurality of devices is received. The second image information is determined according to second anchor information. Using a processor, a representation of the first image is created based on the first image information and the first anchor information. Using the processor, a representation of the second image is created based on the second image information and the second anchor information. The representation of the first image and the representation of the second image are presented simultaneously on the third device.

Certain embodiments may provide one or more technical advantages. A technical advantage of an embodiment includes the ability to communicate image information in terms of an anchor point identified on a background image. Another technical advantage of an embodiment includes the ability to reduce bandwidth requirements involved in communicating changing image information. The image information may be communicated in terms of anchor information and contain only those attributes that have changed since prior transmissions of image information. Another technical advantage of an embodiment includes the ability to increase the number of remote devices for which a presentation device may receive and present image information. Another technical advantage of an embodiment allows for transmission of display data from multiple remote devices without reliance on traditional video streaming.

Certain embodiments may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of particular embodiments and for further features and advantages thereof, reference is now made to the following description taken in conjunction with the accompanying drawings, in which:

FIG. 1 illustrates an example system for displaying image information from a plurality of devices.

FIG. 2 illustrates a system comprising a plurality of user devices communicating with a presentation device.

FIG. 3 is a flowchart illustrating an example method for displaying image information from a plurality of user devices.

### DETAILED DESCRIPTION OF EXAMPLE EMBODIMENTS

FIG. 1 illustrates an example system 10 for displaying image information from a plurality of devices. System 10 includes a presentation device 104 that communicates with computer 106 and user devices 110 over network 102. In particular embodiments, user devices 110 communicate image information to be displayed on presentation device 104. Where appropriate, the user devices 110 may be remote from presentation device 104. In particular embodiments, the image information communicated from one or more user devices 110 is presented on a common display 108.

In particular embodiments, display panels of user devices 110 include static, fixed, and/or a known background or anchor-positioned content. Display attributes of display panels may be communicated to presentation device 104 and/or computer 106 in relation to this known anchor. As such, the entire display of devices 110 may be constructed on presentation device 104 and/or common display 142 without the use of streaming video or other streaming media. By only communicating attributes such as x/y coordinates, tool type, annotation color, and/or other specific attributes, data communication may be kept very small, which may allow multiple devices 110 (e.g., thousands or hundreds of thousands of remote devices) to be displayed in real-time without the use of streaming, be it streaming audio/video or other streaming media.

As one example, users of devices 110 may annotate a background image presented on the display of user devices 110. The image information corresponding to the annotation may be described relative to an anchor point identified in the background image. Presentation device 104 may present representations of the displays of the user devices 110 using the content originally displayed, the received image information, and the anchor information. Where appropriate, updates to the images of the user devices 110 may be described solely in terms of the changes occurring since the prior image information was communicated.

Communicating image information in relation to a known anchor point may help to reduce bandwidth and/or capacity requirements when compared with communications that solely use video streaming/compression techniques. The components of system 10 may work in combination with such techniques where appropriate. System 10 may be used in any suitable environment where image information is communicated from user devices 110, including an education environment. An “education environment” may be a traditional classroom environment, a meeting, a focus group, or any other gathering in which an instructor or moderator interacts with a group using display 108.

The components of system 10 communicate using network 102. Network 102 represents any suitable network that facilitates communication between the components of system 10. Network 102 may include any interconnecting system capable of transmitting audio, video, signals, data, messages, or any combination of the preceding. Network 102 may comprise all or a portion of one or more of the following: a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication link, any other suitable communication link, including combinations thereof operable to facilitate communication between the components of system 10.

In certain embodiments, network 102 represents a wireless network accessible to components of system 10 and inaccessible to the general public. For example, network 102 may be a wireless network principally located at a school or in a classroom of a school. Additionally, presentation device 104 and devices 110 may communicate directly over network 102 or may communicate indirectly through computer 106 as will be described in some of the examples detailed below.

Presentation device 104 represents any suitable device operable to receive image information from devices 110. Non-limiting examples of presentation device 104 include a tablet, mobile phone, personal digital assistant, laptop, netbook, ultrabook, desktop computer, and/or any other suitable device. Lightweight embodiments of presentation device 104 comprising a wireless network interface, such as a tablet computer embodiment, may allow a user of device 104 to move unencumbered in a classroom or other setting among the users of devices 110. In particular embodiments, presentation device 104 includes a network interface 112, memory 114, processor 118, and graphical user interface 120.

Graphical user interface 120 displays information and/or available functionality to a user of presentation device 104. In particular embodiments, graphical user interface 120 allows its user to select an interactive activity to be performed by users of devices 110. The instructor may also select specific content (e.g., a background image) to be displayed on devices 110 while the users of devices 110 engage in the interactive activity. Presentation device 104 causes the content to be delivered to devices 110 by sending it directly to devices 110, by causing computer 106 to deliver the content to devices 110, and/or in any other suitable manner. An analysis of the content to be delivered to user devices 110 may be performed to determine a suitable anchor point. The content and anchor information corresponding to the determined anchor point may be delivered to user devices 110.

As the display shown on each user device 110 changes, image information from the devices 110 may be communicated to presentation device 104 for display in real-time on presentation device 104. One of ordinary skill in the art will recognize that “real-time” operations may accommodate certain time-lapses or delays inherent in using communication devices, such as presentation device 104 and user devices 110.

In certain embodiments, users of devices 110 engage in an interactive activity involving annotation of a background image shown on user devices 110. While the users of devices 110 engage in the interactive activity and enter annotations on the displayed content, representations of the displays of devices 110 (including the respective annotations of each user) may appear in a film strip 122 on graphical user interface 120 as thumbnails 124. The representations provided in thumbnails 124 may change in real-time as the users enter annotations on devices 110. The image information received from devices 110 may comprise information associated with the user annotations described as a function of the previously determined anchor information.

Film strip 122 may appear in any suitable format. For example, film strip 122 may have an adjustable size depending on the number of user devices 110 providing image information. For example, film strip 122 may have multiple rows of thumbnails 124, such that image information from all devices 110 is simultaneously viewable in film strip 122. The size of each thumbnail 124 may change (e.g., get smaller) to accommodate displaying thumbnails 124 that correspond to image information received from a large number of devices 110.

In certain embodiments, film strip 122 may include any suitable control features such as arrow 126. An instructor may select arrow 126 to reveal additional thumbnails 124 not currently shown on presentation device 104. In certain embodiments, presentation device 104 may be configured to allow the instructor to use a finger swipe, a mouse, and/or any other suitable input feature to reveal additional thumbnails 124 not currently shown on presentation device 104.

Graphical user interface 120 may also include content sharing control 128. Content sharing control 128 facilitates presentation of representations of the displays of devices 110 onto common display 108. For example, a user using presentation device 104 may drag and drop one or more thumbnails 124 onto content sharing control 128, which causes the image information to be displayed on common display 108. Graphical user interface 120 allows the user of presentation device 104 to order the selected thumbnails 124 in any suitable order/layout on content sharing control 128, which may be reconfigured by the user at any time. The order/layout chosen for content sharing control 128 may be mirrored on common display 108, although the size may change when reproduced onto common display 108. The image information from devices 110 may be presented on common display 108 as the images shown on devices 110 change (i.e., in real-time).

In certain embodiments, content sharing control 128 may show image information from fewer devices 110 than that shown on common display 108. This may be helpful in such cases where the number of devices 110 with image information to be shown exceeds the amount comfortably viewable on content sharing control 128 of presentation device 104 at once. In such embodiments, a user of presentation device 104 may still drag and drop any suitable number of thumbnails 124 onto content sharing control 128 to cause them to be displayed on display 108.

Where appropriate, presentation device 104 may be configured to automatically cause image information from all devices 110 in system 10 to be presented on common display 108. In particular embodiments, once the particular devices 110 have been selected for presentation on common display 108, presentation device 104 may choose a suitable display configuration for image information from selected devices 110. The configuration chosen for presentation on common display 108 may be chosen based on number of thumbnails 124 selected for presentation, content of the image information, and/or any other suitable factor. For example, presentation device 104 may choose automatically to lay out representations corresponding to selected devices 110 in any suitable number of rows when the number chosen for display exceeds a specified threshold.

As another example, presentation device 104 may cause the representation corresponding to selected devices 110 to be displayed in rotating fashion (e.g., when the representations are fairly detailed). In this example, one, two, or any other suitable number of representations may be displayed on common display 128 for a specified amount of time before being removed and replaced with another set of representations corresponding to other devices 110, continuing through the remaining representations to be displayed and repeating again with the first set of annotations. While the particular representations are displayed, they may continue to be updated in real-time as the images on the respective devices 110 change. In particular embodiments, presentation device 104 may be configured to cycle through the actively changing displays of devices 110 while passing over the displays of devices 110 that have remained stagnant for an amount of time that exceeds a certain threshold. In certain embodiments, presentation device 104 may pause the rotation for any suitable amount of time, such that the particular representations shown on display 108 remains the same. This may allow an instructor using device 104 to provide feedback and/or other instruction to all users of devices 110.

Network interface 112 represents any suitable device operable to receive information from network 102, perform suitable processing of the information, communicate to other devices, or any combination of the preceding. For example, network interface 112 may be used to deliver an instruction for particular content and/or suitable anchor information to be delivered to devices 110 for new annotations. Where appropriate, this content may be communicated directly to devices 110 and/or through computer 106. Network interface 112 represents any port or connection, real or virtual, including any suitable hardware and/or software, including protocol conversion and data processing capabilities, to communicate through a LAN, WAN, or other communication systems that allows presentation device 104 to exchange information with the other components of system 10.

Memory 114 stores, either permanently or temporarily, data, operational software, or other information for processor 118. Memory 114 includes any one or a combination of volatile or nonvolatile local or remote devices suitable for storing information. For example, memory 114 may include random access memory (RAM), read only memory (ROM), magnetic storage devices, optical storage devices, or any other suitable information storage device or a combination of these devices. While illustrated as including particular modules, memory 114 may include any suitable information for use in the operation of presentation device 104.

In certain embodiments, memory 114 includes logic 116. Logic 116 represents any suitable set of instructions, logic, or code embodied in a non-transitory, computer readable medium and operable to facilitate the operation of presentation device 104. For example, logic 116 may include operating system code, application files, and/or rules for indicating the appropriate content to display on graphical user interface 120 under various circumstances, such as while annotations are being entered on devices 110. Logic 116 may reference information stored in data 117. Data 117 may include, for example, content that the presentation device 104 causes to be communicated to be displayed on devices 110 for annotation. The content for annotation may include, for example, math problems, a structure that needs labeling, and/or any other suitable example. Data 117 may also store image information and/or updated image information received from devices 110. Presentation device 117 may retrieve this prior image information when creating a representation of the display of a device 110

Processor 118 communicatively couples to network interface 112 and memory 114. Processor 118 controls the operation and administration of presentation device 104 by processing information received from network interface 112 and memory 114. Processor 118 includes any hardware and/or software that operates to control and process information. For example, processor 118 executes logic 116 to control the operation of presentation device 104. Processor 118 may be a programmable logic device, a microcontroller, a microprocessor, any suitable processing device, or any suitable combination of the preceding.

Computer 106 represents any suitable device that communicates with presentation device 104, user devices 110, and display 108. In certain embodiments, computer 106 drives the operation of system 10 and the components within system 10, such as presentation device 104, display 108, and user devices 110. To facilitate the communication and display of information, computer 106 executes applications, such as a word processing application, a presentation application, a training program, a web browser, an educational application, a web-based application, or any other suitable application. In certain embodiments, computer 106 includes a wireless interface 130, processor 132, network interface 134, and memory 136. Computer 106 includes any suitable type of device that manipulates data according to instructions, such as a personal computer, a laptop, a desktop, or any other suitable type of computer.

Wireless interface 130 represents any suitable element that communicates wireless signals. For example, wireless interface 130 may include an antenna, sensor, emitter, receiver, transmitter, or other suitable component to communicate a wireless signal. Wireless interface 130 represents any port or connection, real or virtual, including any suitable hardware and/or software that allows presentation device 104 to communicate wireless signals. Wireless signals may include any suitable wireless signal, such as a radio frequency signal (e.g., 802.11 or Wi-Fi signal), an infrared signal, or any other suitable wireless signal.

Processor 132 processes information to exchange with presentation device 104 and user devices 110 and transmits information to display 108. Processor 132 may also manage components in system 10. For example, processor 132 runs an application that manages the information communicated to display 108. Processor 132 includes any hardware, software, or both that operate to control and process information in system 10. For example, processor 132 may be a programmable logic device, a microcontroller, a microprocessor, any suitable processing device, or any combination of the preceding. In a particular embodiment, processor 132 is the central processing unit of a personal computer. In another embodiment, processor 132 is distributed among components of system 10.

Network interface 134 represents any suitable element that communicates information between computer 106 and a public or private network. Network interface 134 may include any port or connection, real or virtual, wireline or wireless, including any suitable hardware, software, or a combination of the preceding.

Memory 136 stores, either permanently or temporarily, data, logic 138, or other information for processing by processor 132. Memory 136 includes any one or a combination of volatile or nonvolatile local or remote devices suitable for storing information. For example, memory 136 may include magnetic media, optical media, CD-ROMs, DVD-ROMs, removable media, any other suitable information storage device, or any suitable combination of these devices. Memory 136 stores logic 138.

Logic 138 represents a set of instructions that processor 132 executes to control the operation of computer 106. Logic 138 includes operating system code, applications, user files, logic modules, or any other executable software or data files. In certain embodiments, logic 138 includes application files operable to analyze content to be displayed on a device 110 and identify a suitable anchor point. Where appropriate, anchor information corresponding to the identified anchor point may be communicated to user devices 110 and/or presentation device 104.

Display 108 represents any suitable component that displays information to the user of presentation device 104 and to users of devices 110. Display 108 may include a monitor, a projection screen, a television screen, or any other suitable device that visually displays information. Display 108 may be a single display simultaneously visible to the user of presentation device 104 and user devices 110. Certain embodiments of display 108 comprise a projector 140 and an adjustable screen 142. Projector 140 may receive information from computer 106 and perform any required translation for projection of an image onto adjustable screen 142.

Display 108 may display representations of displays of user devices 110 in the configuration chosen by presentation device 104. The size of screen 142 may be increased or reduced in any suitable manner to accommodate displaying any suitable number of representations of displays of devices 110 selected for display by presentation device 104. In particular embodiments, adjustable screen 142 may be a wall in the classroom. In such embodiments, the size of adjustable screen 142 may be adjusted by configuring the controls of projector 140, moving projector 140 closer or further away from the wall, any other suitable manner of adjustment, and/or any suitable combination of the preceding.

User devices 110 represent any suitable device for sending information to computer 106 and/or presentation device 104 over network 102. User devices may include any suitable device, such as any of the devices listed as possibilities for presentation device 104 above. User devices 110 communicate image information corresponding to their displayed content relative to an anchor point in the image. In certain embodiments, user devices 110 initially receive the content to display from computer 106 and/or presentation device 104 as well as anchor information corresponding to an identified anchor point. In particular embodiments, user devices 110 identify a suitable anchor point in an image to be displayed on its display and communicate annotations to the image displayed and anchor information to computer 106 and/or presentation device 104. One user may use each device 110 or multiple users may share a particular device 110.

While in annotation mode, certain annotation tools may become available to users of devices 110, such as a pen tool for “writing” on top of displayed content, an eraser tool for removing all or a portion of the entered annotation, a color selection tool for selecting the color of annotations entered on top of displayed content. User devices 110 may communicate image information corresponding to their respective displays as they are updated by users of devices 110 to presentation device 104 and/or computer 106.

Certain embodiments of user devices 110 include a network interface, memory, and processor similar in form and function to network interface 112, memory 114, and processor 118, respectively, of presentation device 104. Application files and rules for displaying/editing content may be customized specifically for user devices 110. For example, user devices 110 may be configured to allow presentation device 104 to have general control over whether devices 110 are in annotation mode, which allows users to annotate displays of devices 110 using annotation tools. As another example, user device 110 may perform as a presentation device such that it shows displays from other devices 110 and/or presentation device 104.

In particular embodiments, application files on user devices 110 may be configured to allow presentation device 104 to cause devices 110 to enter a lock mode, which prohibits users of devices 110 from providing further modifications to the annotations entered. User devices 110 may communicate using any suitable type of wireless signal, such as a radio frequency signal or an infrared signal.

In an example embodiment operation of system 10, a user of presentation device 104 selects an activity to interactively engage the students in a classroom who use devices 110. The instructor chooses a math problem activity for the users of devices 110 to solve. The instructor may state the math problem orally and cause a blank screen to appear on devices 110. In certain embodiments, presentation device 104 may cause devices 110 to display an image that includes a specified math problem. The instructions for devices 110 to display certain content and allow users of devices 110 may be delivered directly to devices 110 and/or via computer 106. Computer 106 and/or presentation device 104 analyzes content to be delivered to user devices 110 to determine a suitable anchor point. The content and anchor information corresponding to the anchor point is communicated to user devices 110.

In the illustrated embodiment, User1 has entered the number “343” on the display of device 110a and User2 has entered the number “462” on the display of device 110b. The users of other devices 110 may also provide annotations on the displays of particular displays. User device 110a prepares image information describing the annotation of “343” in relation to the identified anchor point. User device 110b prepares image information describing the annotation of “426” in relation to the identified anchor point. In certain embodiments, the anchor point is the same for both user device 110 and user device 110b.

As the users provide annotations on their respective devices 110, the representations of the displays of devices 122 (including the user annotations) may appear as thumbnails 124 on film strip 122. For example, each digit of the number “343” will appear in real-time on thumbnail 124a, in other words, as User1 enters the annotation on device 110a. Likewise, the annotations entered by the users of the other devices 110 will appear as thumbnails in film strip 122, with the annotations appearing in real-time. Presentation device 104 creates a representation of the display of device 110a by referencing the content originally communicated to device 110a and interpreting the image information subsequently received from device 110a in light of the anchor point determined for device 110a. Presentation device 104 creates a representation of the display of device 110b by referencing the content originally communicated to device 110b and interpreting the image information subsequently received from device 110b in light of the anchor point determined for device 110b.

The user of presentation device 104 has chosen representations of eight devices 110 to appear on common display 108 by dragging certain thumbnails 124 from film strip 122 and dropping them onto content sharing control 128. The instructor may choose any suitable display order for the representations and/or presentation device 104 may choose a display configuration automatically. The representations from selected devices 110 are displayed on common display 108 as they are being edited on devices 110. For example, each digit of the number “462” will appear in real-time on common display 108, as User2 enters the annotation on device 110b, via generation and receipt of updated image information from device 110b.

Presentation device 104 may cause the appropriate representations to appear on common display 108 by transmitting the representations to computer 106 for display on common display 108, instructing computer 106 to present the appropriate representation on common display 108 as received from devices 110, and/or in any other suitable manner.

Modifications, additions, or omissions may be made to system 10. For example, system 10 may include any suitable number of user devices 110. As another example, computer 106 may include a display in addition to common display 108. As yet another example, system 10 may include more than one presentation device 104. Where appropriate, presentation device 104 may be programmed to choose and/or allow an instructor to selectively choose different content to be displayed on specific devices 110 for annotation. For example, device 110a may display an image of a math problem to be solved while, at the same time, device 110b displays a diagram to be identified and labeled by the user of device 110b. In such embodiments, the anchor point for the math problem content may be determined to be different from the diagram content.

Moreover, the operations of system 10 may be performed by more, fewer, or other components. Any suitable logic comprising software, hardware, other logic, or any suitable combination of the preceding may perform the functions of system 10. For example, the functions of computer 106 may be performed by presentation device 104 in certain embodiments.

FIG. 2 illustrates a system 302 comprising user devices 304 communicating with a presentation device 308. User devices 304 may be used as user devices 110 and presentation device 308 may be used as a presentation device 104 in system 10 of FIG. 1 and/or any other suitable system. Presentation device 308 presents image information of user devices 304 in real-time as the displays for devices 304 change, for example, in response to annotation of a background image shown on displays 304.

An anchor point is determined for the content to be delivered to devices 304. In particular embodiments, an anchor point is determined by analyzing the content to be delivered for certain metrics. For example, choosing the region in the content with the highest contrast as the anchor point may be beneficial when reconstructing images at different sizes/scaling than the original. In certain embodiments, the anchor point size may be larger or smaller, and/or the anchor point may be determined by searching for metrics different or in addition to contrast, such as color, shape, and/or any other suitable metric.

The anchor information may describe the anchor point in terms of position information, contrast, color, shape any other suitable metric, and/or any other suitable combination of the preceding. For example, positional anchor information may take the form of coordinates, pixel number, absolute/percentage distance measurements from edge of display, and/or any other suitable metric. Thus, in certain embodiments, a square-shaped anchor point may be defined in terms of coordinates of its four corners, the coordinate of a corner plus an attribute defining one or more lengths of its sides, and/or suitable metric. In particular embodiments, a circular-shaped anchor point may be defined in terms of its center point and an attribute defining is radius.

In certain embodiments (e.g., where the content to be delivered to devices 304 comprises a series of images and/or a video), the anchor information may also include a temporal component to describe the identified anchor point.

In certain embodiments, presentation device 308 selects an image annotation activity and delivers an image of a math problem to user devices 304. The math problem is titled “Example #1” and is “14÷7·2−3.” The math problem image may be analyzed to determine a suitable anchor point in the image. In particular embodiments, the math problem content is analyzed to identify a 16 by 16 pixel region in the image with highest contrast, which then may be defined as the anchor point. The math problem content is delivered to a device along with the anchor information identifying the determined anchor point.

For illustrative purposes, regions 307 pictorially define areas identified as an anchor point for math problem content displayed on devices 304. The anchor point may not be visible to users of devices 304 and/or may not be identified to the users of devices 304 as the anchor point.

At the same time that the content of the math problem is delivered to devices 304, presentation device 308 may cause devices 304 to enter an annotation mode, such that the image of the math problem may be annotated by users of devices 304. While in annotation mode, certain embodiments of devices 304 will enable user annotation tools, such as user annotation tools 306. User annotation tools 306 include a pen tool, eraser tool, color selection tool, a width selection tool, and any other suitable annotation tools.

The annotation tools may be used to annotate content displayed on devices 304. The attributes related to the annotation may be communicated in the form of image information to presentation device 104. For example, if a user enters an annotation with a “pen” tool, the image information may indicate the tool used as a pen, the color as black, the width of the line created, the relative position of the annotation related to the anchor point (e.g., x-y position with anchor point as the origin), and/or any other suitable information. In particular embodiments, a message with image information includes an annotation tool identifier, a width attribute, a color attribute, a shape attribute, an x-position attribute, a y-position attribute, an order attribute, an attribute indicating whether a button is pressed, a device identifier, and/or any other suitable attribute.

In certain embodiments, the annotation color, contrast, width, and/or any other suitable information may be defined as a function of the anchor point. For example, annotation color may be defined as a difference from the color of the anchor point.

As the users of devices 304 begin to annotate the math problem, the annotations appear on presentation device 308. The image information is received and interpreted by computer 106 and/or presentation device 104. The image information may be used to recreate the annotations and combine those annotations with the content originally sent to devices 304 to create a representation of the displays on user devices 304. The representations may be scaled to suitably display one or more of the representations in film strip 310.

Film strip 310 presents each of the annotations entered on devices 304 represented by thumbnails 312. For example, thumbnail 312 shows that the user of device 304a initially entered “2·−1” to attempt to solve the math problem. The user of device 304a may have realized that this violated the correct order of operations for mathematics equations and crossed that line out. The user of device 304a then entered “2·2−3,” utilizing the correct order of operations. Each step of the user's annotation is viewable as thumbnail 312a on presentation device 312 as it is entered on device 304a.

As another example, presentation device 308 presents the real-time annotation of device 304c as thumbnail 312c on film strip 310. The user of device 304c appears to be a bit distracted drawing a smiley face instead of attempting to solve the math problem presented. Because the annotation entered on device 304c is presented on presentation device 308 in real-time, the instructor or other user of presentation device 308 may be alerted to this conduct nearly immediately and, thus, may engage the user of device 304c directly to rectify the situation.

Likewise, the user of device 304d has not made much progress in solving the math problem, which may indicate that the user needs assistance. The progress of the annotation of device 304d is also presented as a thumbnail on film strip 310 (not shown). As with the distracted user of device 304c, the instructor or other user of presentation device 308 may engage the user of device 304d directly to determine the reason for the lack of progress and initiate a solution. Thumbnails 312 not currently shown, such as thumbnail 312d corresponding to the annotation entered on device 304d, may be revealed by using a finger swipe on film strip 310, using a arrow selector controlled by a computer mouse to manipulate the film strip, using instructor controls 314 to manipulate the display of presentation device 314, and/or by any other suitable manner. Film strip 310 may comprise any suitable number of thumbnails 312 to facilitate presentation of the annotations of devices 304 presented in system 302. In certain embodiments, film strip 310 may include a maximum number of 100 thumbnails 312.

The instructor or other user of presentation device 308 may cause the representations of one or more devices 304 to appear on a common display simultaneously viewable by users of multiple devices 304, such as common display 108 of system 10 of FIG. 1. In certain embodiments, this may be accomplished by dragging any suitable number of thumbnails 312 onto content sharing control 316. Presentation device 308 may order the representations in any suitable manner on content sharing control 316 in any suitable layout. In particular embodiments, content sharing control 316 includes the representations of device 304a and 304b, which incorporate annotations entered by User1 and User2, respectively. The real-time annotations of these users will be presented on a common display.

Lock mode control 318 may be selected to cause devices 304 to stop the annotations of devices 304. While in lock mode, users of devices 304 will not be able to modify the annotations already entered on devices 304 and will not be able to provide additional annotations. In certain embodiments, instructing devices 304 to enter lock mode will cause devices 304 to temporarily display a “lock” symbol or other indicator to alert the users of devices 304 that annotation is currently prohibited. Lock mode control 318 may be selected again to cause devices 304 to re-enter annotation mode.

Selection of stop control 320 may end the current interactive activity. In certain embodiments, upon stopping the activity, the annotations of devices 304 may be saved on user devices 304, presentation device 308, a control computer such as computer 106 of system 10, any other suitable storage mechanism, and/or any other suitable combination of the preceding.

Modifications, additions, or omissions may be made to system 302. For example, presentation device 308 may present any suitable number of thumbnails 312 simultaneously in film strip 310. As another example, content sharing control may include any suitable number of thumbnails 312, thus causing any suitable number of annotations to be presented on a common display.

FIG. 3 is a flowchart illustrating an example method 400 for displaying image information from a plurality of user devices. At step 401, content for display on the user device is determined. At step 402, anchor information is determined for the content. The anchor information may be derived from an anchor point identified in the content by a separate computer such as computer 106, a presentation device such as presentation device 104, and/or in any other suitable manner. At step 404, the content and the anchor information are communicated to the user devices. The content may be displayed as a background image on the user devices.

At step 406, image information is received from the user devices. The image information may comprise annotations entered on top of the content displayed on the user devices. The image information may be described in relation to the anchor point of the content. At step 408, representations of the user devices are created. The representations may be created by combining the content previously communicated to the user devices and the image information received from the user devices. The image information may comprise any differences from the content originally displayed on user devices described in terms of the anchor point of the content. In certain embodiments, image information comprises attributes associated with any annotations entered on the user devices. At step 410, the representations of the displays of the user devices are presented on a presentation device, such as presentation device 104. In particular embodiments, the representations may appear as thumbnail images in a film strip.

At step 412, the method determines whether any changes have occurred in the displays of the user devices. If not, the method may end. If the displays on the user devices are continuing to change, the method may return to step 406 where image information is received again. In particular embodiments, this may be updated image information comprising solely the differences occurring since the previous transmission of image information.

Modifications, additions, and omissions may be made to method 400 disclosed herein without departing from the scope of particular embodiments. Although described in a particular sequence, the steps in the flowchart may occur serially or in parallel in any suitable order. Additionally, the methods may include more, fewer, or other steps. For example, in certain embodiments, the user device may determine the content displayed on the user device and determine a suitable anchor point for that content. The user device may send the content and the anchor information to a presentation device. The user device may send changes made to the content in the form of image information described in terms of the anchor point. Subsequent transmissions of updated image information may be only changes since the previous transmission of image information. As another example, method 400 may include an additional step where representations of user devices may be displayed on a common display.

A component of the systems and apparatuses disclosed herein may include an interface, logic, memory, and/or other suitable element. An interface receives input, sends output, processes the input and/or output, and/or performs other suitable operations. An interface may comprise hardware and/or software. Logic performs the operations of the component. For example, logic executes instructions to generate output from input. Logic may include hardware, software, and/or other logic. Logic may be encoded in one or more non-transitory, tangible media, such as a computer readable storage medium or any other suitable tangible medium, and may perform operations when executed by a computer. Certain logic, such as a processor, may manage the operation of a component. Examples of a processor include one or more computers, one or more microprocessors, one or more applications, and/or other logic.

Although particular embodiments been described, a myriad of changes, variations, alterations, transformations, and modifications may be suggested to one skilled in the art, and it is intended that the certain embodiments encompass such changes, variations, alterations, transformations, and modifications as fall within the scope of the appended claims.

What is claimed is:

1. A method for displaying image information from a plurality of devices, comprising:
receiving first image information corresponding to part of a first image displayed on a first device of a plurality of devices, wherein the first image information is determined according to first anchor information;
receiving second image information corresponding to part of a second image displayed on a second device of the plurality of devices, wherein the second image information is determined according to second anchor information;
creating, using a processor, a representation of the first image based on the first image information and the first anchor information; and
creating, using the processor, a representation of the second image based on the second image information and the second anchor information; and
presenting the representation of the first image and the representation of the second image simultaneously on the third device.

2. The method of claim 1, further comprising:
communicating the first anchor information to the first device; and
communicating the second anchor information to the second device.

3. The method of claim 1, further comprising determining the first anchor information by performing a contrast analysis of content to be displayed on the first device.

4. The method of claim 1, wherein the first anchor information and the second anchor information are the same.

5. The method of claim 1, further comprising:
presenting the representation of the first image and as a first thumbnail image on the third device; and
presenting the representation of the second image as a second thumbnail image on the third device.

6. The method of claim 1, wherein the first image information corresponds to an annotation of a background image displayed on the first device.

7. The method of claim 1, wherein the first image information determined according to the first anchor information comprises at least one of a set of x-y coordinates, an annotation tool type, and an annotation color.

8. The method of claim 1, the method further comprising:
receiving updated first image information corresponding to a part of the first image that has changed since receiving the first image information, wherein the updated first image information is determined according to the first anchor information; and
updating the representation of the first image presented on the third device based on the updated first image information and the first anchor information.

9. A system for displaying image information from a plurality of devices, comprising:
a memory comprising rules for displaying image information from a plurality of devices;
a graphical user interface for presenting representations of displays of the plurality of devices; and
a processor communicatively coupled to the memory and operable to:
receive first image information corresponding to part of a first image displayed on a first device of the plurality of devices, wherein the first image information is determined according to first anchor information;
receive second image information corresponding to part of a second image displayed on a second device of the plurality of devices, wherein the second image information is determined according to second anchor information;
create a representation of the first image based on the first image information and the first anchor information; and
create a representation of the second image based on the second image information and the second anchor information; and
present the representation of the first image and the representation of the second image simultaneously on the graphical user interface.

10. The system of claim 9, the processor further operable to:
communicate the first anchor information to the first device; and
communicate the second anchor information to the second device.

11. The system of claim 9, the processor further operable to determine the first anchor information by performing a contrast analysis of content to be displayed on the first device.

12. The system of claim 9, wherein the first anchor information and the second anchor information are the same.

13. The system of claim 9, the processor further operable to:
present the representation of the first image and as a first thumbnail image on the graphical user interface; and
present the representation of the second image as a second thumbnail image on the graphical user interface.

14. The system of claim 9, wherein the first image information corresponds to an annotation of a background image displayed on the first device.

15. The system of claim 9, wherein the first image information determined according to the first anchor information comprises at least one of a set of x-y coordinates, an annotation tool type, and an annotation color.

16. The system of claim 9, the processor further operable to:
receive updated first image information corresponding to a part of the first image that has changed since receiving the first image information, wherein the updated first image information is determined according to the first anchor information; and
update the representation of the first image presented on the graphical user interface based on the updated first image information and the first anchor information.

17. A non-transitory computer readable medium comprising logic, the logic when executed by a processor, operable to:
receive first image information corresponding to part of a first image displayed on a first device of a plurality of devices, wherein the first image information is determined according to first anchor information;
receive second image information corresponding to part of a second image displayed on a second device of the plurality of devices, wherein the second image information is determined according to second anchor information;
create, using a processor, a representation of the first image based on the first image information and the first anchor information; and
create, using the processor, a representation of the second image based on the second image information and the second anchor information; and
present the representation of the first image and the representation of the second image simultaneously on a third device.

18. The computer readable medium of claim 17, wherein the logic is further operable to:
communicate the first anchor information to the first device; and
communicate the second anchor information to the second device.

19. The computer readable medium of claim 17, wherein the logic is further operable to determine the first anchor information by performing a contrast analysis of content to be displayed on the first device.

20. The computer readable medium of claim 17, wherein the first anchor information and the second anchor information are the same.

21. The computer readable medium of claim 17, wherein the logic is further operable to:
present the representation of the first image and as a first thumbnail image on the third device; and
present the representation of the second image as a second thumbnail image on the third device.

22. The computer readable medium of claim 17, wherein the first image information corresponds to an annotation of a background image displayed on the first device.

23. The computer readable medium of claim 17, wherein the first image information determined according to the first anchor information comprises at least one of a set of x-y coordinates, an annotation tool type, and an annotation color.

24. The computer readable medium of claim 17, the wherein the logic is further operable to:
receive updated first image information corresponding to a part of the first image that has changed since receiving the first image information, wherein the updated first image information is determined according to the first anchor information; and
update the representation of the first image presented on the third device based on the updated first image information and the first anchor information.
